(19) United States
(12) Patent Application Publication
(10) Pub. No.: US 2024/0181608 A1
(43) Pub. Date: Jun. 6, 2024

(54) FASTENER MANIPULATION DEVICE

(71) Applicant: Debra Catherine Monday, Westfield, MA (US)

(72) Inventor: Debra Catherine Monday, Westfield, MA (US)

(21) Appl. No.: 18/521,054

(22) Filed: Nov. 28, 2023

Related U.S. Application Data
(60) Provisional application No. 63/429,589, filed on Dec. 2, 2022.

(51) Int. Cl. B25B 13/50

(52) U.S. Cl. CPC B25B 13/50

(57) ABSTRACT

A fastener manipulation device may include a handle which may be engaged to a driver. The handle may have a handle shaft, and a handle channel may extend through the handle shaft. A driver may have a receiver shaft and an engagement shaft which may be coupled together in a linear orientation. The receiver shaft may include a receiver aperture which may be disposed in the end of the receiver shaft that is most distal to the engagement shaft. The engagement shaft may include an engagement aperture which may be disposed in the end of the engagement shaft that is most distal to the receiver shaft. The handle may be engaged to the driver by inserting the engagement shaft through the handle channel which allows the engagement shaft and therefore the driver to rotate relative to the handle.

### CROSS REFERENCE TO RELATED APPLICATIONS

This application claims priority to and the benefit of the filing date of U.S. Provisional Application No. 63/429,589, filed on Dec. 2, 2022, entitled “FASTENER MANIPULATION DEVICE”, which is hereby incorporated by reference in its entirety.

### FIELD OF THE INVENTION

This patent specification relates to the field of devices which are configured to manipulate hardware and fasteners. More specifically, this patent specification relates to a device which may be used to remove or otherwise manipulate she bolt fasteners and other objects.

### BACKGROUND

During construction of buildings and other structures, workers are required to manipulate fasteners, such as she-bolts, and other objects by removing and attaching the fasteners at various locations. She-bolts are heavy duty, reusable form ties for medium and heavy concrete construction. They are used with inside rods or coil rod that can be cut in the field to any desired length based on form thickness that is required. She-bolts are meant to be reused, and are removed when the forms are removed. Removal of she-bolts is labor intensive, and the currently available hand tools are not ergonomic or easy to operate.

Therefore, a need exists for a novel fastener manipulation device which enables a user to manipulate fasteners and remove she-bolts in a quick and easy manner.

### BRIEF SUMMARY OF THE INVENTION

A fastener manipulation device is provided which may be used to manipulate fasteners, such as to remove she-bolts from concrete forms. In some embodiments, the device may include a handle which may be engaged to a driver. The handle may have an elongated handle shaft, and a first guard may be coupled to the elongated handle shaft. An elongated handle channel may extend through the handle shaft and the first guard. The driver may have an elongated receiver shaft, and an elongated engagement shaft. The elongated receiver shaft and the elongated engagement shaft may be coupled together in a linear orientation. The receiver shaft may include a receiver aperture which may be disposed in an end of the receiver shaft that is most distal to the engagement shaft. The engagement shaft may include an engagement aperture which may be disposed in an end of the engagement shaft that is most distal to the receiver shaft. The engagement shaft may be received in the handle channel to engage the handle to the driver so that the engagement shaft, and therefore the driver, are able to be rotated relative to the handle. A user may insert a portion of a fastener, such as a she-bolt, within the engagement aperture and an impact bit of an impact driver or other tool into the receiver aperture. The user may then rotate and manipulate the fastener via the tool while holding onto the handle shaft to steady the rotational movement of the driver.

In further embodiments, the device may include a second guard that may be coupled to the elongated handle shaft, and the elongated handle channel may extend through the handle shaft, the first guard, and the second guard.

In further embodiments, the engagement aperture and the receiver aperture may be linearly aligned with each other

### BRIEF DESCRIPTION OF THE DRAWINGS

Some embodiments of the present invention are illustrated as an example and are not limited by the figures of the accompanying drawings, in which like references may indicate similar elements and in which:

FIG. 1-FIG. 1 depicts a perspective view of an example of a fastener manipulation device according to various embodiments described herein.

FIG. 2-FIG. 2 illustrates a perspective exploded view of an example of a fastener manipulation device according to various embodiments described herein.

FIG. 3-FIG. 3 shows a perspective view of an example of a handle according to various embodiments described herein.

FIG. 4-FIG. 4 depicts a first perspective view of an example of a driver according to various embodiments described herein.

FIG. 5-FIG. 5 illustrates a second perspective view of an example of a driver according to various embodiments described herein.

FIG. 6-FIG. 6 shows a sectional, through line 6-6 shown in FIG. 5, elevation view of an example of a driver according to various embodiments described herein.

FIG. 7-FIG. 7 depicts a partial perspective view of the end of an engagement shaft that is distal to the receiver shaft of a driver according to various embodiments described herein.

FIG. 8-FIG. 8 illustrates a partial perspective view of the end of a receiver shaft that is distal to the engagement shaft of a driver according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

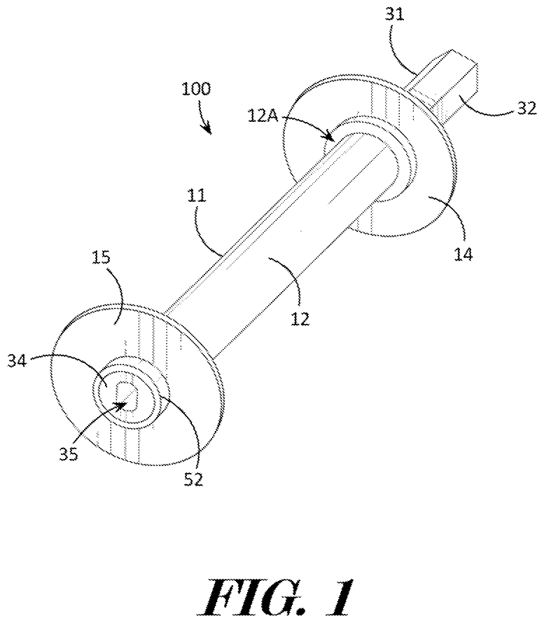

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 15% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new fastener manipulation device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

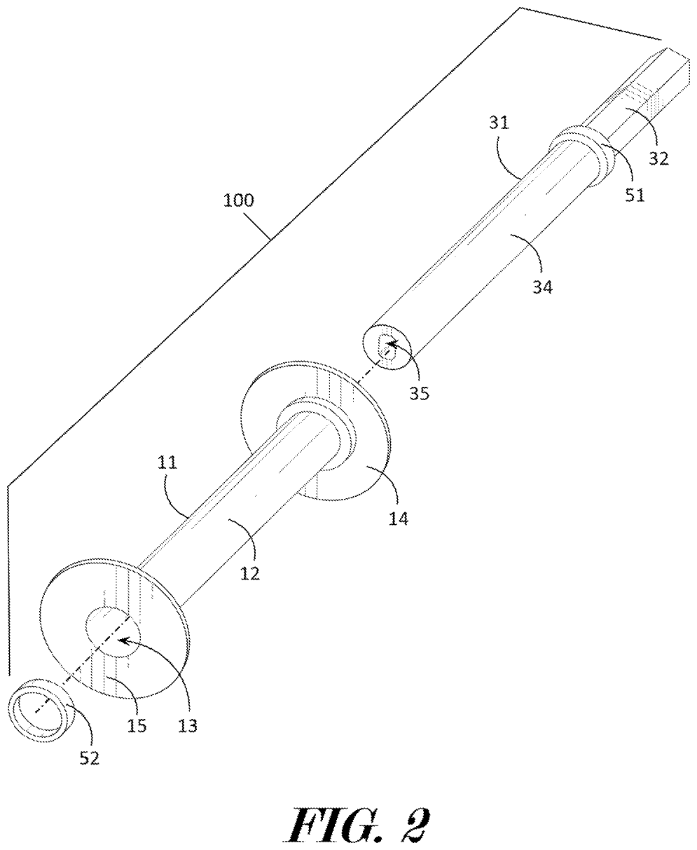

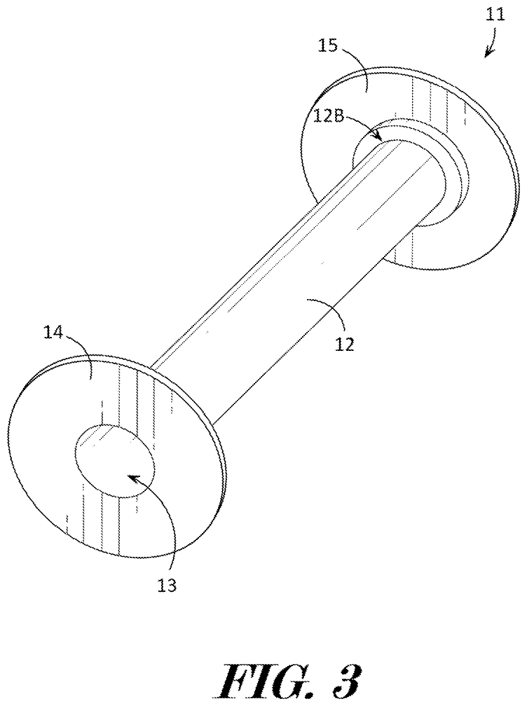

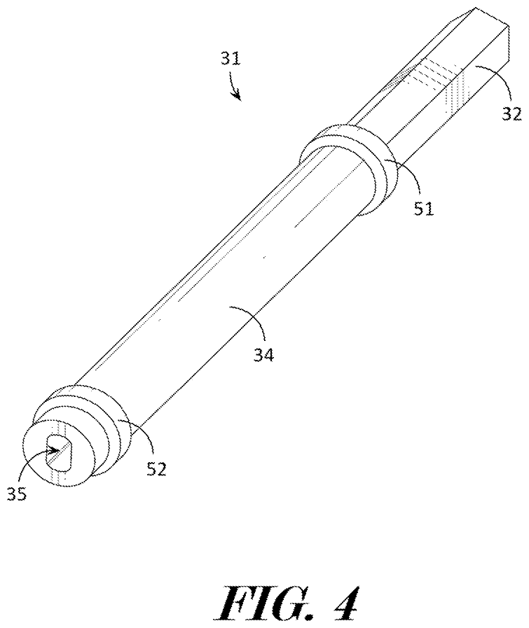

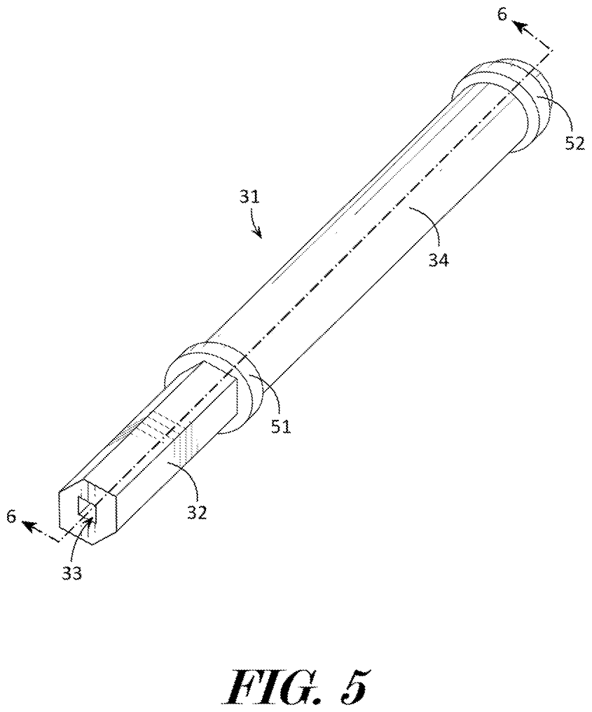

The present invention will now be described by example and through referencing the appended figures representing preferred and alternative embodiments. FIGS. 1 and 2 illustrate an example of a fastener manipulation device (“the device”) 100 according to various embodiments. In some embodiments, the device 100 may comprise a handle 11 which may be engaged to a driver 31. The handle 11 may comprise a handle shaft 12, and a handle channel 13 may extend through the handle shaft 12. Preferably, a first guard 14 and a second guard 15 may be coupled to opposing ends of the handle shaft 12. A driver 31 may comprise a receiver shaft 32 and an engagement shaft 34 which may be coupled together in a linear orientation. The receiver shaft 32 may include a receiver aperture 33 which may be disposed in the end of the receiver shaft 32 that is most distal to the engagement shaft 34. The engagement shaft 34 may include an engagement aperture 35 which may be disposed in the end of the engagement shaft 34 that is most distal to the receiver shaft 32. The handle 11 may be engaged to the driver 31 by inserting the engagement shaft 34 through the handle channel 13 to allow the engagement shaft 34 and therefore the driver 31 to rotate relative to the handle 11. A user may insert a portion of a fastener, such as a she-bolt, within the engagement aperture 35 and an impact bit of an impact driver or other tool into the receiver aperture 33. The user may then rotate and manipulate the fastener positioned within the engagement aperture 35 via the rotation of the impact bit of the impact driver or other tool while holding onto the handle shaft 12 to steady the rotational movement of the driver 31.

In some embodiments, the device 100 may comprise a handle 11 which may be configured in any shape and size. Preferably, one or more of the components of a handle 11 may be made from aluminum or other durable material. The handle 11 may comprise an elongated handle shaft 12 which may be configured to be held or gripped by the hand of a user. In preferred embodiments, a handle shaft 12 may comprise an elongated cylindrical shape having a length which may enable the whole hand of a user to grip the handle shaft 12. For example, a handle shaft 12 may comprise approximately a 5.5 inch length and approximately a 1.5 inch width or diameter. Optionally, a handle shaft 12 may comprise grip enhancing texturing, a cushioning and/or non-slip material, or any other ergonomic enhancing device or method.

The handle 11 may comprise an elongated handle channel 13 that may extend through the elongated handle shaft 12. Generally, the handle channel 13 may be sized to allow all or a portion of the engagement shaft 34 to extend through the handle channel 13 and to rotate freely within the handle channel 13. For example, a handle channel 13 may comprise approximately a 1.25 inch width. Preferably, the handle channel 13 may be sized to be slightly larger in diameter than the diameter of the engagement shaft 34 to prevent the engagement shaft 34 from wobbling in the handle channel 13 while still allowing the engagement shaft 34 to rotate freely within the handle channel 13. A handle channel 13 may be configured in any shape and size. In preferred embodiments, the handle channel 13 may be cylindrical in shape.

In preferred embodiments, a handle 11 may comprise one or more guards 14, 15, which may prevent a user's hand from slipping off one or both ends of the handle shaft 12. The elongated handle channel 13 may extend through the handle shaft 12 and through each guard 14, 15. A guard 14, 15, may be configured in any size and shape that may be larger in size than the width of the handle shaft 12. For example, a guard 14, 15, may be generally annular or ring shaped and perpendicularly coupled to an end of the handle shaft 12 which may have approximately a 3.0 inch width or diameter. In preferred embodiments, the device 100 may comprise a first guard 14 which may be coupled to a first end 12A of the handle shaft 12 and a second guard 15 that may be coupled to the opposing second end 12B of the handle shaft 12. In further embodiments, a guard 14, 15, may be coupled at any location on the handle shaft 12.

The device 100 may comprise a driver 31 which may be configured to simultaneously engage a fastener or other object that a user desires to rotate and a tool, such as an impact driver, ratchet, socket, etc. A driver 31 may comprise a receiver shaft 32 and an engagement shaft 34 which may be coupled together in a linear orientation. Preferably, the driver 31 may comprise or may be made from hardened steel or other suitable durable material.

A receiver shaft 32 may be configured in any shape and size. Preferably, a receiver shaft 32 may be hexagonal prism shaped, such as by having six rectangular lateral faces 36A, 36B, 36C, 36D, 36E, 36F, and a hexagonal base 37. In preferred embodiments, a receiver shaft 32 may comprise an elongated hexagonal prism shape, such as approximately a 2.5 inch length and approximately a 1.25 inch width. By having a hexagonal prism shape, the receiver shaft 32 may be received in a hex socket which may be engaged to an impact driver, ratchet, etc. In further embodiments, a receiver shaft 32 may be configured in any shape and size.

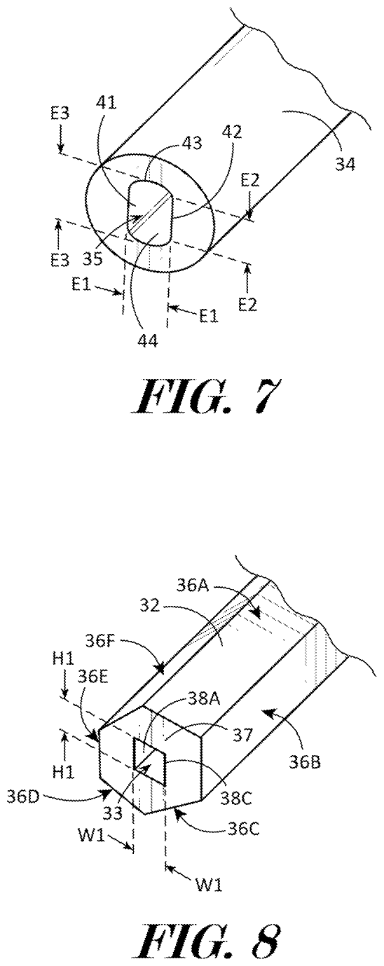

In preferred embodiments, a receiver shaft 32 may comprise a receiver aperture 33 which may be disposed in the end of the receiver shaft 32 that is most distal to the engagement shaft 34. A receiver aperture 33 may be configured in any size and shape to enable a bit, driver head, or other tool to be received in the receiver aperture 33. In preferred embodiments, a receiver aperture 33 may comprise a rectangular prism shape, such as by having four rectangular lateral walls 38A, 38B, 38C, 38D, and a square base 39, and the receiver aperture 33 may comprise a width dimension (W1) and a height dimension (H1) (FIG. 8) that may each describe the distance between a set of two opposing lateral walls 38A, 38B, 38C, 38D. In some embodiments, the width dimension (W1) and the height dimension (H1) may each be substantially half of an inch so that the receiver aperture 33 may be may be used to receive a standard half-inch drive ratchet, bit, etc. In further embodiments, the width dimension (W1) and the height dimension (H1) may each be substantially three-quarters of an inch (0.75 inches) so that the receiver aperture 33 may be may be used to receive a standard three-quarters drive ratchet, bit, etc. In further embodiments, the width dimension (W1) and the height dimension (H1) may each be between approximately 0.4 to 0.85 inches. It should be understood that a receiver aperture 33 may be configured in any size and shape to enable a bit, other sized driver heads, or other tools to be received in the receiver aperture 33.

In preferred embodiments, an engagement shaft 34 may comprise an elongated cylindrical shape, such as approximately a 6.0 inch length and approximately a width that is slightly smaller than the width of the handle channel 15 (e.g., a width of 1.24 inches if the handle channel 15 has a width of 1.25 inches). By having a cylindrical shape, the elongated engagement shaft 34 may be received in the elongated handle channel 15 (that preferably may also be cylindrical in shape) so that the engagement shaft 34 may rotate freely within the handle channel 15. In further embodiments, an engagement shaft 34 may be configured in any shape and size.

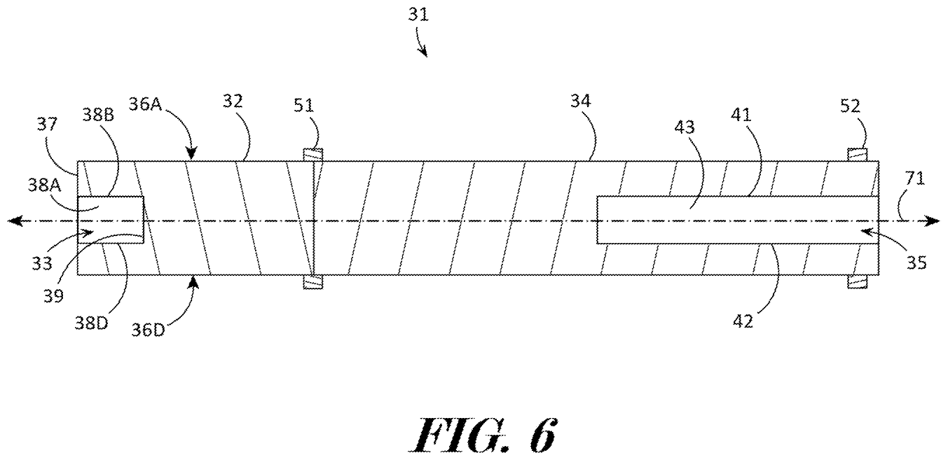

In preferred embodiments, an engagement shaft 34 may include an engagement aperture 35 which may be disposed in the end of the engagement shaft 34 that is most distal to the receiver shaft 32. The device 100 may also comprise an elongated axis 71 which may bisect the driver 31 along the elongated length of the receiver shaft 32 and along the elongated length of the engagement shaft 34 as perhaps best shown in FIG. 6. Generally, the engagement aperture 35 may extend into the engagement shaft 34 and the receiver aperture 33 may extend into the receiver shaft 32 so that the apertures 33, 35, are linearly aligned with each other so that they are bisected by the elongated axis 71 as perhaps best shown in FIG. 6. By being linearly aligned, the apertures 33, 35, may be bisected by the elongated axis 71 along their respective lengths (the distance that they each extend into the driver 31 as perhaps best shown in FIG. 6.

An engagement aperture 35 may be configured in any size and shape to enable a portion of a she-bolt or other fastener to be received in the engagement aperture 35 in a manner that prevents the she-bolt or other fastener from rotating independently from the engagement shaft 34. In preferred embodiments, an engagement aperture 35 may extend approximately 3.0 inches into the engagement shaft 34.

In some embodiments, an engagement aperture 35 may comprise two generally flat or planar walls 41, 42, which may be opposingly positioned to each other so that they face each other. Preferably, the planar walls 41, 42, may be substantially parallel to each other. The engagement aperture 35 may comprise a first dimension (E1) (FIG. 7) that may describe the distance between the planar walls 41, 42, and the first dimension (E1) may be approximately 0.5 inches. In further embodiments, the first dimension (E1) may be between approximately 0.4 to 0.85 inches.

In some embodiments, an engagement aperture 35 may comprise two generally curved walls 43, 44, which may be opposingly positioned to each other so that they face each other. Each curved wall 43, 44, may be coupled to both of the planar walls 41, 42. Preferably, the curved walls 43, 44, may be convex curved relative to each other so that they are curved away from each other. The engagement aperture 35 may comprise a second dimension (E2) that may describe the distance that the planar walls 41, 42, separate the curved walls 43, 44, from each other. In some embodiments, the second dimension (E2) (FIG. 7) may be approximately 0.625 inches. In further embodiments, the second dimension (E2) may be between approximately 0.4 to 0.85 inches. The engagement aperture 35 may comprise a third dimension (E3) (FIG. 7) that may describe the maximum distance that the curved walls 43, 44, extend from each other. In some embodiments, the third dimension (E3) may be approximately 0.59 inches (approximately 0.59 inches apart mid-curve). In further embodiments, the third dimension (E3) may be between approximately 0.4 to 0.85 inches.

In some embodiments, the device 100 may comprise a handle collar 51 that may be coupled to the driver 31, optionally at the junction of the receiver shaft 32 and engagement shaft 34. Generally, a handle collar 51 may comprise a protrusion that extends above the exterior surface of the receiver shaft 32 and/or engagement shaft 34 which may be configured to hold and keep the handle 11 in place during use and as an ergonomic spacer. In preferred embodiments, the handle collar 51 may be generally annular shaped or ring shape and may encircle a portion of the receiver shaft 32 and/or engagement shaft 34.

In preferred embodiments, the device 100 may comprise a locking collar 52 which may be coupled to the engagement shaft 34 once the engagement shaft 34 is inserted through the handle channel 13. Generally, a locking collar 52 may be coupled to the engagement shaft 34 so that the handle 11 may be retained on the engagement shaft 34 between the handle collar 51 and locking collar 52. Optionally, a handle collar 52 and/or a handle collar 51 may be removably coupled to the engagement shaft 34 to enable the handle 11 and driver 31 to be removably coupled together. For example, a handle collar 52 and/or a handle collar 51 may be removably coupled to the engagement shaft 34 via threading to enable the handle 11 and driver 31 to be removably coupled together.

The handle 11 may be engaged to the driver 31 by inserting the engagement shaft 34 through the handle channel 13 to allow the engagement shaft 34 and therefore the driver 31 to rotate relative to the handle 11. Preferably, the device 100 may comprise a handle collar 51 and a locking collar 52 that are both coupled to the engagement shaft 34, and the engagement shaft 34 may be received in the handle channel 13 so that the handle 11 is positioned between the handle collar 51 and the locking collar 52 so that the handle 11 may be rotationally coupled or rotationally retained (able to rotate relative to the engagement shaft 34) on the engagement shaft 34.

The device 100 may be used to manipulate a she-bolt or other fastener or object, such as by rotating the she-bolt or other fastener or object. She-Bolts are heavy duty, reusable form ties for medium and heavy concrete construction. They are used with Inside Rods or Coil Rod that can be cut in the field to any desired length based on form thickness that is required. She-Bolts are meant to be reused, but they do wear so they must be continually inspected.

To use the device 100, having the engagement shaft 34 inserted a through the handle channel 13 and rotatably coupled to the handle 11 which allows the engagement shaft 34 and therefore the driver 31 to rotate relative to the handle 11, to manipulate a she-bolt or other fastener or object, a user may insert a portion of a fastener, such as a she-bolt, within the engagement aperture 35. Optionally, an impact bit of an impact driver or other tool may be inserted into the receiver aperture 33. Optionally, a hex socket, such as which may be coupled to an impact driver or other tool, may be positioned over the hexagonal shaped prism receiver shaft 32. The user may then rotate the driver 31 via the tool to rotate and manipulate the fastener while holding onto the handle shaft 12 to steady and to direct the rotational movement of the driver 31 and fastener.

While some exemplary shapes and sizes have been provided for elements of the device 100, it should be understood to one of ordinary skill in the art that the handle 11, driver 31, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A fastener manipulation device, the device comprising:
a handle having:
i. an elongated handle shaft;
ii. a first guard coupled to the elongated handle shaft;
iii. an elongated handle channel that extends through the handle shaft and the first guard; and
a driver having:
i. an elongated receiver shaft; and
ii. an elongated engagement shaft, wherein the elongated receiver shaft and the elongated engagement shaft are coupled together in a linear orientation, wherein the receiver shaft comprises a receiver aperture which is disposed in an end of the receiver shaft that is most distal to the engagement shaft, wherein the engagement shaft comprises an engagement aperture which is disposed in an end of the engagement shaft that is most distal to the receiver shaft, and wherein the engagement shaft is received in the handle channel to engage the handle to the driver so that the engagement shaft, and therefore the driver, are able to be rotated relative to the handle.

2. The device of claim 1, wherein the elongated engagement shaft is cylindrical in shape.

3. The device of claim 1, wherein the elongated handle channel is cylindrical in shape.

4. The device of claim 1, wherein the receiver aperture is rectangular prism in shape.

5. The device of claim 1, wherein the receiver aperture comprises a width dimension and a height dimension, and wherein the width dimension and the height dimension are each substantially half of an inch.

6. The device of claim 1, wherein the receiver shaft is hexagonal prism shaped.

7. The device of claim 1, further comprising a handle collar and a locking collar that are both coupled to the engagement shaft, wherein the engagement shaft is received in the handle channel so that the handle is positioned between the handle collar and the locking collar.

8. The device of claim 1, wherein the engagement aperture has two planar walls that are opposingly positioned to each other.

9. The device of claim 1, wherein the engagement aperture has two curved walls that are opposingly positioned to each other.

10. The device of claim 9, wherein the two curved walls are curved away from each other.

11. A fastener manipulation device, the device comprising:
a handle having:
i. an elongated handle shaft;
ii. a first guard and a second guard that are both coupled to the elongated handle shaft;
iii. an elongated handle channel that extends through the handle shaft, the first guard, and the second guard; and
a driver having:
i. an elongated receiver shaft; and
ii. an elongated engagement shaft, wherein the elongated receiver shaft and the elongated engagement shaft are coupled together in a linear orientation, wherein the receiver shaft comprises a receiver aperture which is disposed in an end of the receiver shaft that is most distal to the engagement shaft, wherein the engagement shaft comprises an engagement aperture which is disposed in an end of the engagement shaft that is most distal to the receiver shaft, wherein the engagement aperture and the receiver aperture are linearly aligned with each other, and wherein the engagement shaft is received in the handle channel to engage the handle to the driver so that the engagement shaft, and therefore the driver, are able to be rotated relative to the handle.

12. The device of claim 11, wherein the elongated engagement shaft is cylindrical in shape.

13. The device of claim 11, wherein the elongated handle channel is cylindrical in shape.

14. The device of claim 11, wherein the receiver aperture is rectangular prism in shape.

15. The device of claim 11, wherein the receiver aperture comprises a width dimension and a height dimension, and wherein the width dimension and the height dimension are each substantially half of an inch.

16. The device of claim 11, wherein the receiver shaft is hexagonal prism shaped.

17. The device of claim 11, further comprising a handle collar and a locking collar that are both coupled to the engagement shaft, wherein the engagement shaft is received in the handle channel so that the handle is positioned between the handle collar and the locking collar.

18. The device of claim 11, wherein the engagement aperture has two planar walls that are opposingly positioned to each other.

19. The device of claim 11, wherein the engagement aperture has two curved walls that are opposingly positioned to each other.

20. The device of claim 19, wherein the two curved walls are curved away from each other.
